(19) United States
(12) Patent Application Publication
(10) Pub. No.: US 2018/0322861 A1
(43) Pub. Date: Nov. 8, 2018

(54) Variable Presence Control and Audio Communications In Immersive Electronic Devices

(71) Applicant: Ahmed Ibrahim, Foster City, CA (US)

(72) Inventor: Ahmed Ibrahim, Foster City, CA (US)

(21) Appl. No.: 16/040,386

(22) Filed: Jul. 19, 2018

Related U.S. Application Data
(63) Continuation-in-part of application No. 15/933,296, filed on Mar. 22, 2018.
Application No. 15/933,296 is a continuation-in-part of application No. 15/802,410, filed on Nov. 2, 2017.
Application No. 15/802,410 is a continuation of application No. 14/685,566, filed on Apr. 13, 2015, now abandoned.
(60) Provisional application No. 62/552,170, filed on Aug. 30, 2017.
(60) Provisional application No. 62/534,197, filed on Jul. 19, 2017.
(60) Provisional application No. 62/474,659, filed on Mar. 22, 2017.
(60) Provisional application No. 61/978,308, filed on Apr. 11, 2014.

(51) Int. Cl. G10K 11/178

(52) U.S. Cl. CPC G10K 11/178; G10K 11/17827; G10K 11/17885; G10K 2210/3016; G10K 2210/3033; G10K 2210/3047; G10K 2210/1081

(57) ABSTRACT

Systems and methods operate to automatically adjust features and modes of operation for personal electronic devices, to control the level of immersion (or conversely, presence) experienced by a user of the device, relative to the user's ambient environment and/or virtual communications from systems other than the immersive device, such as notifications or bot communications. Thus, users of electronic devices may still make themselves available for interaction with other individuals and devices around them, even while using technologies that may otherwise be immersive and isolating.

### TECHNICAL FIELD

The present disclosure relates in general to electronic devices providing immersive user experiences, and in particular to systems and methods for variable presence control and audio communications in immersive electronic devices.

### BACKGROUND

With the proliferation of smartphones, tablets, laptop computers, wearable computing devices, augmented reality devices, virtual reality devices, mixed reality devices, and the like, electronic devices capable of engaging user attention have become ubiquitous and omnipresent. As technology progresses, many applications of such technology are becoming increasingly immersive, engaging one or more of a user's senses to the exclusion or diminution of others.

Immersive technologies may be highly stimulating, entertaining, informatory, or otherwise productive and beneficial for users. However, immersive characteristics, combined with the increasing amounts of time such devices are used by or available to individuals, may give rise to negative consequences as well. In some situations, immersive devices may preclude or inhibit positive social interactions with other people, bots or devices. For example, immersive technologies may reduce an individual's ability to engage socially with friends and family. In the workplace, immersive devices may inhibit productive interaction between coworkers. Users engaged in immersive device experiences may be perceived as unapproachable by others when in a public domain, thereby forcing users to choose between enjoying such device experiences and making themselves readily available for social interaction. Users engaged in immersive device experiences may be unable to perceive notifications from bots or devices, such as a spoken reminder to attend to a task or depart for an appointment. Such binary choices may inhibit an individual's creativity or productivity. In some circumstances, immersive device engagement may even present safety risks, as users may be unaware of their surroundings. On the other hand, a desire to avoid such problems and disadvantages may actually reduce the frequency and duration of occasions in which individuals use immersive technologies, thereby reducing the potential value that may be delivered by them.

### SUMMARY

Systems and methods operate to automatically adjust features and modes of operation for personal electronic devices, to control the level of immersion (or conversely, presence) experienced by a user of the device, relative to the user's ambient environment and/or virtual communications from systems other than the immersive device, such as notifications or bot communications. Thus, users of electronic devices may still make themselves available for interaction with other individuals and devices around them, even while using technologies that may otherwise be immersive and isolating.

### BRIEF DESCRIPTION OF THE DRAWINGS

FIG. 1 is a schematic block diagram of a computing environment in which some embodiments may be implemented.

FIG. 2 is a process for adjusting device operation in response to interaction events, in accordance with a first embodiment.

FIG. 3 is a second embodiment of a process for adjusting device operation in response to interaction events.

FIG. 4 is a schematic block diagram of an exemplary environment in which a presence controller may be utilized.

FIG. 5 is a mobile device user interface for use of presence control groups.

FIG. 6 is a perspective view of an earphone that may be utilized in some embodiments.

FIG. 7 is a schematic block diagram of headphones in operable communication with a personal electronic device, interacting with a cloud-based presence control server.

FIG. 8 is a process for voice triggered control over presence state.

FIG. 9 is a schematic block diagram of PEDs in operable communication with a presence controller for delivery of audio messages.

FIG. 10 is a process diagram for delivery of audio messages.

FIG. 11 is a process diagram for two-way audio communications.

FIG. 12 is a schematic block diagram of a system for audio-based chatbot support within a retail environment.

FIG. 13 is a schematic block diagram of PEDs with spatially distributed audio microphones.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

In some embodiments, systems and methods may facilitate social interaction between individuals who are heavily immersed in use of a technology device, and people or other devices around them. This may be achieved, for example, by syncing control of interruptions to the devices, and/or syncing of data shared across devices, based on, e.g., the user, user preferences and/or conditions within the user's local environment.

Different electronic devices may be capable of providing different levels and types of user sense immersion. For example, headphones (used alone or with another device producing audio output) may provide audio-based immersion for a user, including preventing or inhibiting a user from sensing other sounds ambient nearby. Noise cancelling headphones may be particularly immersive. In ear monitors or earbuds, particularly those that seal a user's ear canal, may also be highly immersive. Virtual reality headsets may be especially immersive, as they typically occupy a user's audio and visual perception and prevent or inhibit the user from perceiving others around them. Similarly, a laptop computer with headphones used for audio output may be highly immersive, consuming a user's audio senses as well as attracting visual attention and focus.

Embodiments may enable a user to be available to others in the local vicinity (all others and/or selected others), on demand, even when using an electronic device that includes sensory immersion. Some embodiments may also make a user of an immersive system available to notifications from external devices and systems, such as bots or remote users of communication systems, even if the external device or system is not directly integrated with the immersive system. Preferably, embodiments further curate relevant interruptions based on, e.g., a particular interaction need or priority.

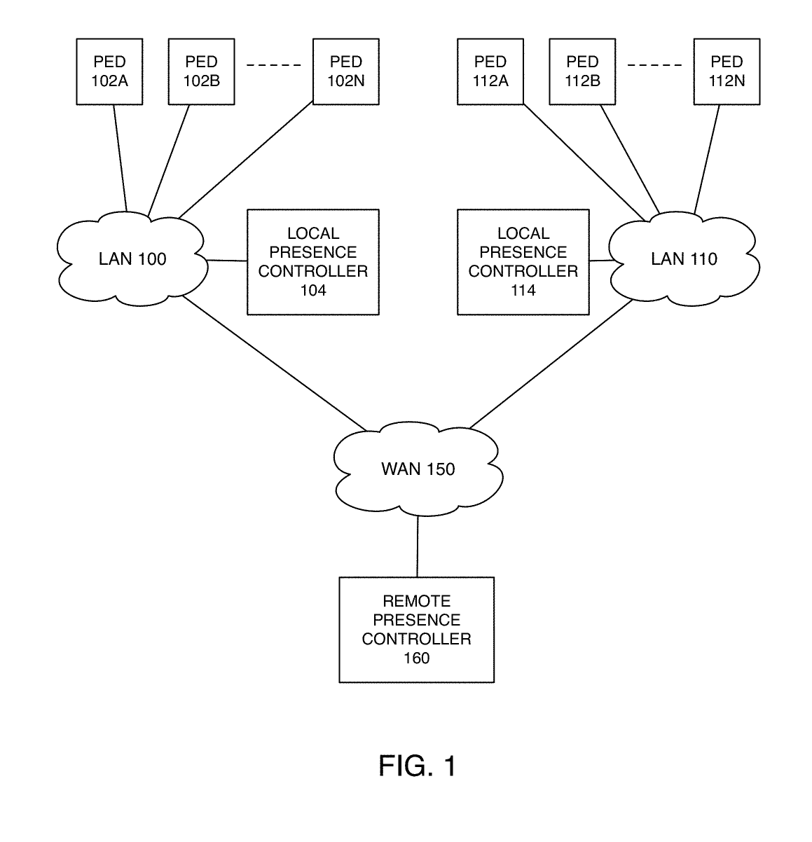

FIG. 1 illustrates an exemplary communications environment in which some embodiments of the invention may be implemented. Local Area Network (LAN) 100 includes multiple personal electronic devices (PEDs) 102A to 102N. PEDs 102 may include, without limitation, smartphones, headphones (e.g. network-enabled and/or controlled by another PED), smart glasses with augmented reality features, virtual reality headsets, computers, tablets, and various combinations of such devices. In some embodiments, local presence controller 104 also communicates via LAN 100.

Systems implementing certain embodiments may include multiple LANs, each in a different geographical area, the same geographical area, or overlapping geographical areas. For example, the embodiment of FIG. 1 further includes LAN 110, via which PEDs 112 communicate, as well as local presence controller 114. Preferably, LANs 100 and 110 are both interconnected with a wide area network that may include the Internet, such as WAN 150. Remote presence controller 160 may be connected with WAN 150 to, inter alia, allow communication amongst the various devices on LAN 100 and LAN 110, as well as with cloud server 160.

LANs such as LAN 100 and LAN 110 may be implemented using one or more communication protocols, such as: wired Ethernet, 802.11 wireless Ethernet, Bluetooth, Zigbee or NFC. In some embodiments, a given local environment may include multiple overlapping LANs using different communication protocols, with which various devices interact.

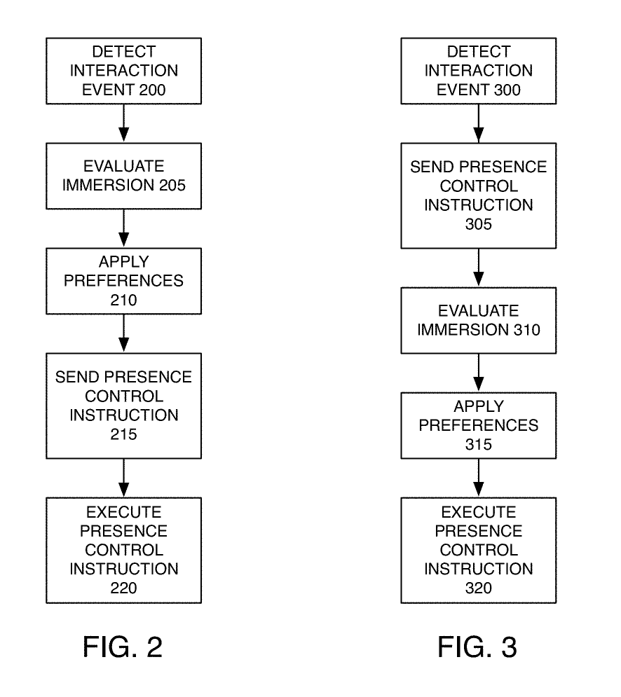

FIG. 2 illustrates a process that may be implemented in the computing environment of FIG. 1. In step 200, an interaction event is detected. An interaction event may include a circumstance in which another individual actually or potentially seeks to interact with a user of an immersive electronic device. Interaction events may be detected in any of numerous ways. In some embodiments, interaction events may be detected locally by sensors integrated within a PED. For example, noise cancelling headphones may include one or more microphones recording ambient sound; an interaction event may be triggered upon detection (e.g. by signal processing application logic within the headphones or within a smartphone with which the headphones are paired) of newly-present ambient sound having a profile (e.g. frequency content) consistent with human voice, and potentially an amplitude above a threshold level, thereby indicative of a nearby individual attempting to speak with the headphone user, or indicative of the headphone user themselves attempting to speak with another person nearby.

Interaction events may also be triggered by other devices. For example, in a smart home, ringing of a network-connected doorbell or door monitoring station may trigger an interaction event, to facilitate interaction of the door visitor with users of immersive devices within the home. Similarly, in a doctor's waiting room or office environment, an individual seeking to make an announcement to others nearby may utilize a computer, smartphone, desk phone, Internet of Things device, or other network-connected device to trigger an interaction event.

Regardless of how the interaction event is triggered, in step 205, the immersion status of users in a location relevant to the interaction event of step 200 is evaluated (whether the relevant users are defined based on their physical location, or virtually based on, e.g., membership in a chat group or social network group). In some embodiments, the immersion evaluation of step 205 may be performed locally on a PED. For example, in an embodiment in which noise cancelling headphone microphones detect the presence of a local voice potentially speaking to the wearer, application logic within the headphones may evaluate whether the headphones are in a noise-cancelling mode of operation or a mode in which external audio is passed through to the wearer, such as described in Applicant's co-pending U.S. Patent Application No. 62/474,659 filed Mar. 22, 2017, U.S. patent application Ser. No. 14/685,566, filed Apr. 13, 2015, and U.S. patent application Ser. No. 15/802,410, the contents of each being hereby incorporated by reference in their entirety. As another example, in an embodiment in which a smartphone or other device is used with a conventional headphone set with onboard microphone, application logic within the smartphone or other device may control whether (and the extent to which) ambient sound is mixed in with audio source signals; in such circumstances, immersion status evaluation in step 205 may be performed by the smartphone or other device application logic.

In some embodiments, evaluation in step 205 may be performed, in whole or in part, by a presence controller 104, active on LAN 100. Presence controller 104 may be implemented in any of a variety of ways. For example, presence controller 104 may be implemented via application logic on a general-purpose compute server, or a dedicated appliance, installed in LAN 100. Presence controller 104 may be implemented via application logic within a PED operating on LAN 100, effectively providing a peer-to-peer and/or distributed presence controller function implemented by PEDs 102. In operation, local presence controller 104 may monitor and evaluate the operation of PEDs 102 on common LAN 100, such as via messaging over LAN 100 with PEDs 102. In such an embodiment, an interaction event detected in step 200 within the environment of LAN 100 may be conveyed to controller 104, thereby initiating evaluation of immersion states of local devices in step 205. In some embodiments, local presence controllers may be implemented within each of multiple LANs over which the system is implemented (e.g. controller 104 on LAN 100, and controller 114 on LAN 110).

In some embodiments, evaluation in step 205 may be performed, in whole or in part, by a remote presence controller 160 implemented on WAN 150 by a cloud server. In such an embodiment, PEDs 102 and 112 may be configured to discover and communicate with remote presence controller 160. In some embodiments, remote presence controller 160 may be utilized in addition to a local presence controller; in other embodiments, remote presence controller 160 may be utilized in lieu of a local presence controller; and yet other embodiments may be implemented without remote presence controller 160.

In step 210, user preferences (if specified and if relevant to a particular interaction) may be evaluated. For example, users may specify time periods and/or locations in which certain types of interactions are desired or undesired, as described further below. Additionally or alternatively, users may also specify certain individuals, devices or other sources or types of interactions as being desired, generally or during certain time periods or at certain locations. In some embodiments, user preferences may be stored in and/or evaluated by any of PEDs 102 and 112, local presence controller, and/or a remote presence controller 160.

Users may also specify preferences manually via a PED. For example, in some embodiments the user's PED may include a smartphone running a mobile application, with standard headphones for user listening. The smartphone app may provide a user interface with controls enabling users to, e.g., toggle on and off mixing of ambient sounds, control ambient sound gain, specify whether an audio source should be paused or attenuated when enabling passthrough of ambient sounds, specify whether the user is available for interactions, and the like.

In step 215, presence control instructions are transmitted to one or more PEDs, based on details of the interaction event detected in step 200, the PED immersion state evaluated in step 205, and any application user preferences evaluated in step 210. Presence control instructions may be addressed to specific PEDs. Presence control instructions may also be broadcast generally, e.g. transmitted on a local network for execution by all devices on the network configured for presence control; such an embodiment may be effective when, for example, a workplace announcement is intended for receipt by all users on the local network.

In embodiments in which the presence controller is integrated within a PED, transmission of presence control instructions in step 210 may be accomplished internally, such as via interaction between a presence controller application logic module and an application logic module implementing device operations (e.g., an application logic module implementing noise cancelling or pass through modes in a headset).

In embodiments in which the presence controller is implemented by local presence controller 104 or 114, transmission of presence control instructions in step 210 may be accomplished via LAN 100 or 110, respectively. In embodiments in which the presence controller is implemented by remote presence controller 160, transmission of presence control instructions in step 210 may be accomplished via various combinations of WAN 150, LAN 100 and/or LAN 110, depending on the location of the PED being addressed.

In step 220, presence control instructions transmitted in step 215 are implemented by receiving PEDs. Details of implementation may depend on the nature of a PED. For example, noise cancelling headphones may be automatically placed into an audio passthrough mode to facilitate audible interaction with the headphones user. In other embodiments, headphones may dynamically adjust modes to vary combination of a primary audio source with ambient sound and/or other audio sources, examples of which are further described in in Applicant's co-pending U.S. patent application Ser. No. 15/802,410, filed Nov. 2, 2017, which is a continuation of U.S. patent application Ser. No. 14/685,566, filed Apr. 13, 2015, which claims the benefit of U.S. Provisional Patent Application No. 61/978,308, filed Apr. 11, 2014, the contents of which are hereby incorporated by reference. A virtual reality headset may toggle into an audio pass through mode, and/or a partial visual passthrough or full visual passthrough mode.

In some embodiments, device content playback may be modified. For example, a smartphone or other audio player or a video player may pause playback, lower playback volume, mix ambient audio sounds into the device's audio output stream, apply equalization or other audio processing to the audio source signal to reduce perceived interference with spoken communications, or various combinations thereof. In yet other embodiments, messaging may be delivered to the user via user interface mechanisms provided by the particular personal electronic device; for example, in a VR headset or on a computer, a notification modal dialog or notification may be rendered within the user's field of view to, e.g., display text or graphic description of the nature of the interaction event, or display video content from the user's location within a portion of the user's field of view.

While the embodiment of FIG. 2 contemplates a presence controller evaluating device status and user preferences when responding to an interaction event, in other embodiments, one or both of these functions may be performed by the personal electronic device on which immersion conditions may be modified. FIG. 3 illustrates one such embodiment. In step 300, an interaction event is detected by a presence controller (e.g. local presence controllers 104 and 114, or remote presence controller 160); or, an interaction event is detected by a PED and conveyed to such a presence controller. In step 305, a presence controller transmits a presence control instruction to one or more PEDs determined to be subject to the interaction event of step 300. In step 310, the receiving PED(s) evaluate the level of immersion (or conversely, presence) provided by the device's current mode of operation, towards determining whether to respond to the interaction event by altering the device's operation towards achieving a different level of immersion. In step 315, the receiving PED further evaluates conditions associated with user preferences, towards determining whether to implement any change in the device's mode of operation evaluated in step 310 or otherwise dependent on the interaction event of step 300. In step 320, the evaluation results of steps 310 and 315 are implemented to modify (or not modify) the mode of operation of the receiving PED. Thus, in the embodiment of FIG. 3, the presence controllers primarily disseminate interaction events and associated presence control instructions to one or more PEDs (potentially in a targeted, addressable manner or broadcast generally); with the receiving PEDs determining whether and how to act on the instruction.

In some embodiments, it may be desirable to implement machine learning components within application logic evaluating responses to interaction events. For example, a default mode of operation for a VR headset may involve providing ambient audio feedthrough and visual notifications in the event of a user's telephone ringing in the vicinity; however, if the user consistently fails to stop system usage to answer the telephone during ring events, an adaptive algorithm may automatically specify a user preference rule precluding the VR headset from responding to future telephone ringing events.

In some embodiments, interruptions and other interactions with nearby people and devices may be fully enabled for any interacting person or device. In other embodiments, it may be desirable to implement user and/or device authorization criteria, such that only certain users and/or devices cause a change in presence state upon interaction. Other criteria, such as time, date and/or location criteria, may be applied to interaction events, in combination with or independently of user and device criteria. For example, during work hours, a user may preclude interruptions or interactions with social friends, while permitting interactions with social friends outside of work hours.

Embodiments may apply to any number of individuals and may be especially useful in a group. For example, a group of individuals may be editing parts of a virtual reality video wearing VR headsets. If one of the team mates wants to interrupt the entire team for a moment, they may click an associated button (or otherwise activate the feature using a component of the headset user interface) to generate an interaction event, which causes each team mate's headset to switch to a transparent mode at once.

The nature of the modification to immersive features applied to a PED may be dependent on criteria such as the individual generating an interaction event, time and/or location. For example, with a user of a virtual reality headset in a work location, interaction initiated by a user's boss may cause full screen interruption, with transparency mode on; interaction initiated by a user's other colleagues may cause a partial-display pop up interruption. Interactions initiated by a user's social acquaintance may cause no interruption at all while during work hours and/or while located at a work location.

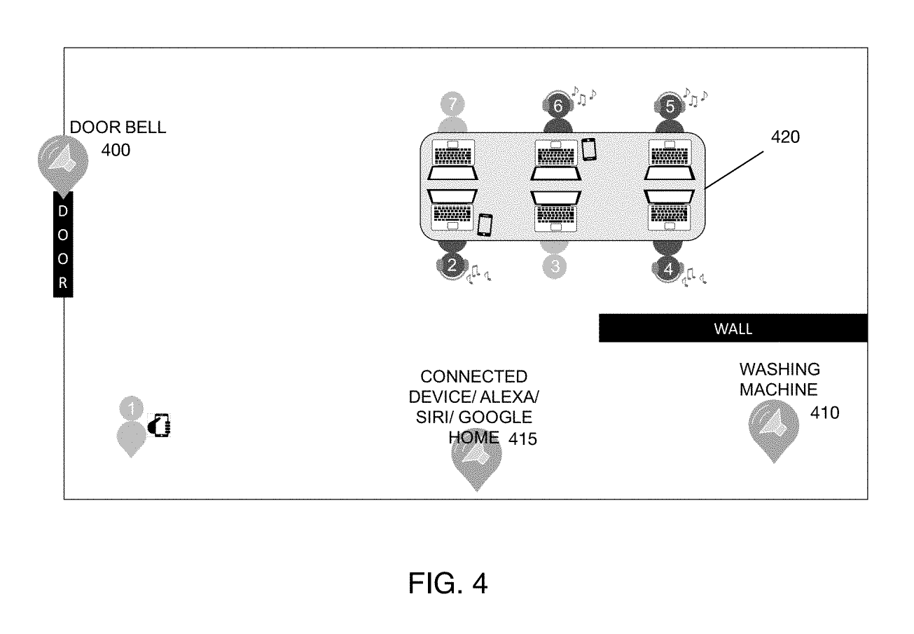

FIG. 4 illustrates an application of embodiments of certain systems and methods described herein, within a group work environment. Individuals with reference numerals 1, 2, 3, 4, 5, 6 and 7 are present within a shared working environment. All individuals except individual 7 are using personal electronic devices connected to a presence controller (not shown). Individuals 2, 4, 5 and 6 are wearing headphones/earphones, and are consuming immersive audio content. Also present within the local area are several network-connected devices, including door bell 400, washing machine 410 and connected home assistant 415 (such as an Amazon Echo or Google Home device), each of which is configured for communications with the presence controller.

In accordance with one scenario, user 2 may wish to address all team members working at table 420. In a conventional scenario, user 2 might pause the user's music, remove their headphones, and then go around to each person attempting to gain their attention to pause their own music, remove their own headphones, and participate in a dialog. However, in the embodiment of FIG. 4 and utilizing methods and apparatuses described hereinabove, user 2 can initiate an interaction by transmitting a local interaction request to the governing presence controller (such as via use of a mobile phone app or laptop computer, in each case communicating with a presence controller). The interaction event is subsequently relayed to personal electronic devices used by other connected users (i.e. individuals 1, 3, 4, 5, and 6). The interaction request is processed by local device application logic to alter device operation and permit a desired level of interaction. For example, headphones worn by users 4, 5 and 6 may be shifted to a conversation mode, in which ambient audio sounds are mixed with source sounds (possibly with overall or frequency band-specific attenuation), in order to permit users 4, 5 and 6 to perceive communications from user 2.

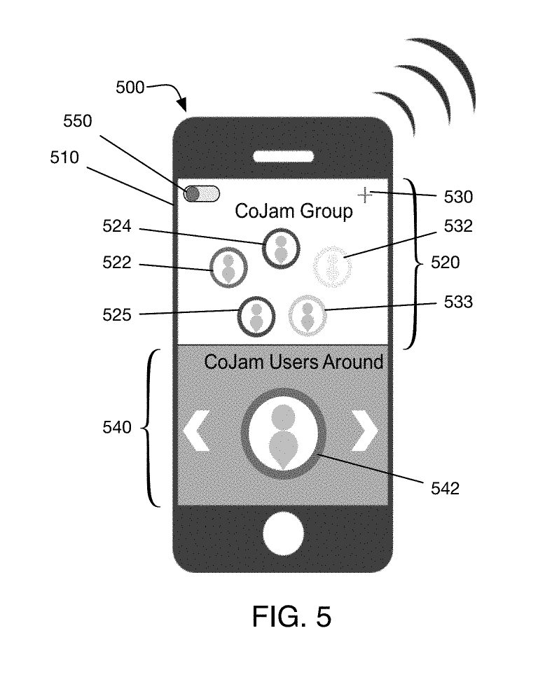

In accordance with another scenario, person 1 may desire to address all individuals in the vicinity. Person 1 is not using an immersive device, but has a smartphone available to them. In a conventional scenario, individuals 2, 4, 5 and 6 would not be able to hear person 1 as a result of their headphone use. However, person 1 may utilize their smartphone to interact with a presence controller to initiate a local interaction request that is conveyed to immersive devices used by other individuals, thereby placing their personal electronic devices into a mode of operation enabling local interaction, such as a conversation mode or pass-through audio mode, such that person 1 may subsequently interact with, and be perceived by, other individuals 2-6. FIG. 5 (described in detail below) illustrates an exemplary application with which person 1 may toggle immersion status for other individuals.

In accordance with yet another scenario, user 4 may be engaged in an important activity (such as an important business telephone call) for which interruptions are undesired. Preferences for user 4 may be configured with the presence controller (such as via a mobile app or web application) to prevent incoming interaction requests from toggling user 4's device into a mode of operation permitting interruptions. In some embodiments, such a preference configuration may be performed manually by user 4, such as by affirmatively toggling an application user interface element into a “Do Not Disturb” mode. In other embodiments, such a preference configuration may be performed automatically, such by the local presence controller querying a VOIP application to identify a telephone number with which user 4 is communicating, which may be identified as a call for which interruptions should be declined. Optionally, individuals in such a “Do Not Disturb” mode may receive a less invasive notification instead, such as haptic feedback, a short sound or brief device notification.

In accordance with yet another scenario, conventionally, headphone users may not perceive a door bell ringing within an occupied space. However, in the embodiment of FIG. 4, network connected door bell 400 may, upon ringing, transmit an interaction request to the presence controller. The presence controller may then forward requests to devices associated with one or more individuals to provide notifications and/or toggle the devices into a mode of operation in which door bell 400 may be perceived. All users may receive such a request, or the request may be directed to specific users based on, for example, their physical location relative to door bell 400, their presence status, their preferences, or other factors.

In accordance with yet another scenario, it may be desirable to utilize presence control, as described herein, to facilitate interactive group or team communications, while mitigating perception of other ambient sounds. For example, users 2, 4, 5 and 6 may be working in a loud co-working space, or subject to background noise by devices such as washing machine 410. Users may utilize music or other audio sources, played over headphones having active and/or passive noise suppression features, to minimize user perception of distracting ambient noise. However, users 2, 4, 5 and 6 may join a common presence control group and utilize presence controller operations to enable sporadic voice communications amongst themselves, while still suppressing other ambient sounds at all other times. In some circumstances, users 2, 4, 5 and/or 6 may manually toggle presence controls for group members. In other circumstances, users 4, 5, 6 and 6 may utilize headsets having microphones capable of detecting a user's own speech, and transmitting a temporary interaction request to the presence control group in response thereto, thereby enabling live, real-time voice chat amongst the team's presence control group, while still suppressing external sounds and interactions at all other times. Such an embodiment may be particularly desirable to facilitate easy collaboration amongst a team, working physically together or distributed, within one or more co-working spaces or other loud environments.

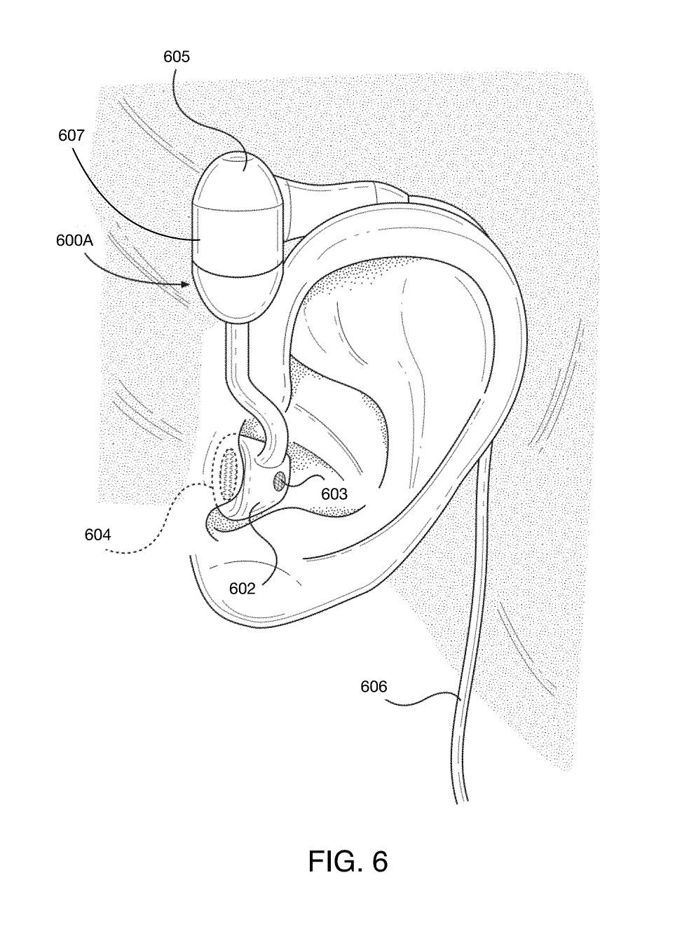

As mentioned above, FIG. 5 illustrates an exemplary mobile application that may be used (for example, by person 1 in the above scenario) for interaction with a local and/or remote presence controller. Mobile phone 500 implements local application logic, implemented by an onboard microprocessor, to render display 510, and communicate with a network-connected presence controller. Display portion 520 provides a schematic illustration of users within a presence control group, with each user represented by an icon or profile picture. A colored ring around each icon or profile picture provides a cue as to the user's present state of immersion, or interruptibility. For example, green visual cue 522 indicates a user having a device configured to permit perception of interruptions or other individuals. Red visual cues 524 and 525 indicate users having a device in an immersive mode of operation, inhibiting the user's perception of others. In some embodiments, visual cues of a user's state of presence such as 522 and 524 may synchronize with physical visual cues present on a user's personal electronic device(s), such as indicator panel 607 in the headphones of FIG. 6, and as described further in Applicant's U.S. Patent Application No. 62/474,659, filed Mar. 22, 2017, and Applicant's U.S. patent application Ser. No. 15/933,296, filed Mar. 22, 2018, the contents of which applications are both hereby incorporated by reference in their entirety. Thus, individuals physically proximate a user may visually identify the user's state of presence both through direct visual observation, as well as through a mobile application display.

Plus icon 530 may be selected to add other users to the presence control group reflected in display portion 520, such that they may interrupt or be interrupted by the user of device 500. In some embodiments (e.g. dependent on user preferences and/or trigger preferences), approval mechanisms may be implemented to require consent from one or more individuals in a presence control group before adding others; as such an embodiment, user icon 532 is reflected in a yellow color, indicating that the user is pending approval of others to join the presence control group. Users who are joined to a presence control group, but currently offline or otherwise disconnected from the presence controller, may be rendered in a gray color, such as user indicium 533.

Display portion 540 provides a further mechanism to discover and add users to a presence control group. The presence controller may implement discovery services to identify users on a common network, in a common geographic area, or otherwise sharing common attributes with the user of device 500. A scrollable list of such users may be presented in display portion 540. In the embodiment of FIG. 5, user indicium 542 indicates another user available for invitation to the presence control group of display region 520. Navigation arrows on either side of indicium 542 may be used to scroll through a list of user indicia for available users, while a selected user can be added to the presence control group of region 520 by dragging-and-dropping indicium 542 into display region 520.

With regard to a presence control group as configured, user interface mechanisms may be provided to a user of device 500 to request presence of an individual user, or of all users within a presence group. For example, if a user of device 500 desires to request presence of an entire group, the user may tap the Presence Group display portion 520. If a user of device 500 desires to request presence of a single user, they can scroll through presence groups members within single user region 540 using left/right navigation icons, and then tap user indicium 542 to request presence of the indicated user.

The embodiment of FIG. 5 also provides a mechanism for a member of a presence group to toggle on and off their participation in the group, thereby controlling whether the user's personal electronic device(s) respond to fellow group member requests to change presence status. In particular, toggle 550 may be selected to toggle between modes in which a user participates in a presence control group, or removes themselves from participation.

While FIG. 5 illustrates a mobile app example of a mechanism for participation in a presence control group, it is contemplated that other mechanisms may also be provided. For example, a web site may be provided, in operable communication with one or more local or remote presence controllers, the web site providing user interface mechanisms for user participation, potentially in a manner analogous to FIG. 5. In other embodiments, controls may be provided directly on varying types of personal electronic devices; for example, earphones may be provided with user interface mechanisms (such as physical buttons, a touch-sensitive surface, or tap sensitivity) to toggle group or individual presence controls.

Voice-Triggered Facilitation of Ambient Sound Perception

In some embodiments, it may be desirable to control ambient sound perception in an automated manner, based on spoken words. For example, in some embodiments, ambient sound may be passed through to a user's ear, potentially mixed with audio content from a personal electronic device, in response to detection of certain spoken keywords (such as a name of the user) within the ambient sound. In other embodiments, ambient sound may be passed through to a user's ear, potentially mixed with audio content from a personal electronic device, in response to detection of any spoken words proximate the user. These and other embodiments may be implemented as follows:

FIG. 6 illustrates an exemplary embodiment implemented in connection with earphones. A pair of earphones 600 includes left earphone 600A, connected with a matching right earphone (not shown) via cord 606. Earphone 600A includes a portion 604 which fits into the user's ear, and includes an audio driver for emitting sound into the user's ear. Inner portion 604 is joined with an outer portion 605 which remains visible outside the user's ear. In some embodiments, indicator panel 607 may be a translucent surface on outer portion 605, behind which a multicolor LED 714 is mounted. In operation, the illumination status and color of LED 714 may be varied, thereby controlling the appearance of indicator panel 607, which may be used to provide a visual cue of the presence control status of a user of earphones 600 to other individuals nearby.

Earphone 600A includes external microphone 603, facing outwards for perception of ambient sounds by earphone 600A. In some embodiments, earphones 600 may include an array of microphones, positioned on different surfaces of the earphones, for better detecting and localizing ambient sounds.

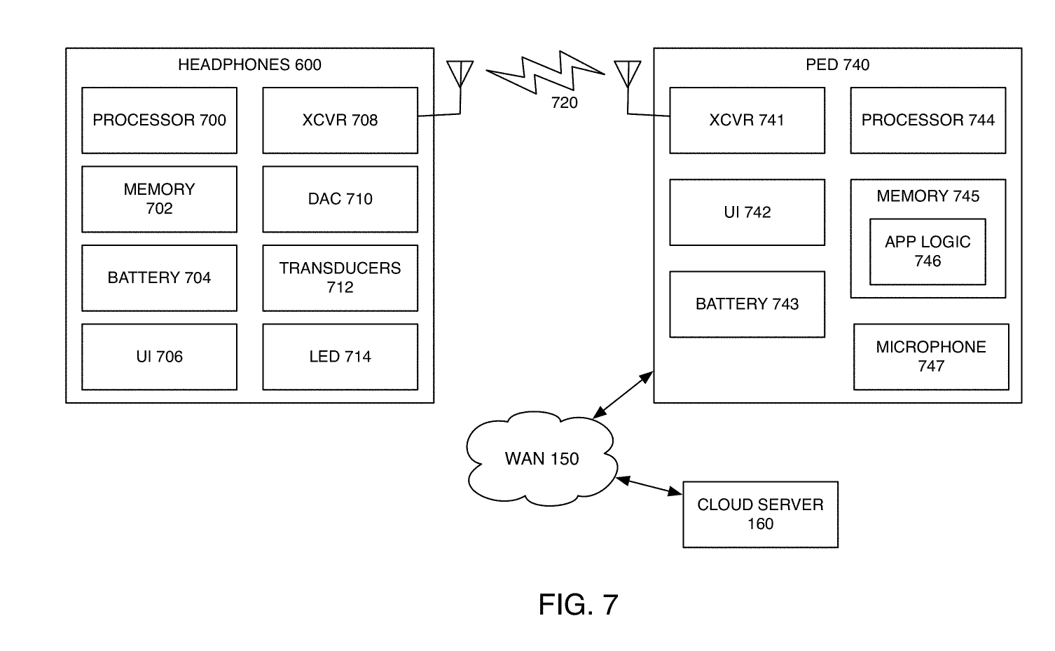

FIG. 7 is a schematic block diagram of earphones 600, as they interact with a user's personal electronic device 740 with which earphones 600 may be used. Earphones 600 include a microprocessor or microcontroller 700, and digital memory 702. Battery 704 provides power to onboard circuitry, enabling wireless use. User interface elements 706 permit direct, local interaction between a user and headphones 600 (and, in particular, application logic implemented on headphones 600 by processor 700 and memory 702). UI 706 may include, without limitation: buttons, switches, dials, touch-sensitive surfaces, voice control engines, optical sensors, and the like.

While some embodiments may be implemented using headphones with special onboard components providing onboard functionality (such as LEDs or other visual indicators to convey device status, or processor 700 for local controls and/or audio processing), it is contemplated and understood that other embodiments may be readily implemented using conventional headphones or headsets, without integration of specially-adapted functionality or components. Most importantly, headphones 600 will preferably provide standard sound emission and microphone functionality. Other functions contemplated by various embodiments herein may typically be implemented by PED 740 (such as via operation of a local application running thereon), by a local presence controller or server, and/or by a cloud presence server 160.

In the wireless headphone embodiment of FIG. 7, wireless transceiver 708 enables digital communication between headphones 600 and other devices, such as personal electronic device 740. In some embodiments, transceiver 708 is a Bluetooth™ transceiver. Digital-to-audio converter 710 converts digital audio signals received by headphones 600 (e.g. via transceiver 708) into analog audio signals, which may then be applied to transducers 712 (which may include, without limitation, audio amplifiers and loudspeakers) to generate sound output.

Light emitting diode (“LED”) unit 714 is controlled by processor 700. In some embodiments, LED unit 714 is a multicolor LED unit capable of turning on and off, varying color and varying brightness. As is known in the art, LED unit 714 may include multiple light emitting diodes of different colors and/or brightnesses operating together to produce varying light output. In some embodiments, LED unit 714 will include multiple LED units operating together, such as one LED unit 714A mounted in a left earphone 600A, and a second LED unit 714B mounted in a right earphone, such that one of LED units 714 may be visible to individuals proximate a wearer of headphones 600, regardless of their position relative to the wearer.

Headphones 600, and in particular transceiver 708, communicate via wireless communication link 720, with personal electronic device (“PED”) 740. In varying embodiments and use cases, PED 740 may be, without limitation: a smartphone, tablet computer, laptop computer, desktop computer, smart watch, smart glasses, other wearable computing devices, home assistant, smart home appliance, or smart television. Headphones 600 may also be utilized in conjunction with multiple PEDs.

PED 740 includes transceiver 741, which in some embodiments may be a Bluetooth transceiver adapted for bidirectional digital communications with headphones transceiver 708. PED 740 also includes user interface components 742, which may include a touch-sensitive display screen. Battery 743 provides power to PED 740 during portable use. Digital memory 745 includes application logic 746. Microprocessor 744 implements application logic 746, and otherwise controls the operation of PED 740.

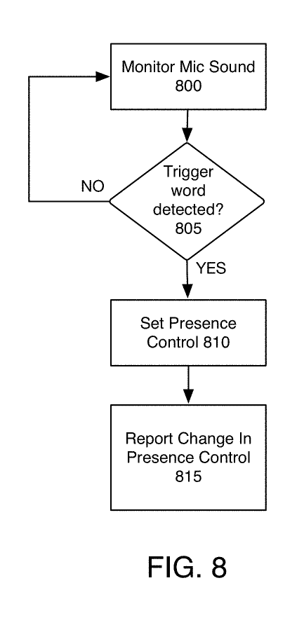

FIG. 8 illustrates a process for voice-triggered facilitation of ambient sound perception, by a smartphone PED 740 running application logic 746 to implement presence control, in conjunction with earphones 600. In step 800, ambient sound perceived by microphone 603 is relayed to a connected smartphone PED 740, and processed by smartphone application logic 746. In step 805, application logic 746 determines whether a triggering event occurs. Exemplary triggering events may include, e.g., perception of an individual speaking the name of the user of PED 740. For example, the user of PED 740 may configure trigger words in connection with a user profile stored in PED memory 745 (and optionally, within a presence control server such as server 160). Trigger words may also be pre-configured within a PED application. Trigger words may include the user's name, nick names, “hey”, or any other terms that may be desirable for triggering a change in immersion status. Trigger words may also include non-language auditory criteria, such as a particular voice signature, pitch, rate of speech, or the like, thereby allowing users to further specify the nature of ambient voice sounds that should toggle awareness.

In some embodiments, PED 740 may include onboard speech recognition services, with recognized words reported back to a local application for comparison to the previously-configured trigger words. In some embodiments, PED 740 may relay audio content (or portions thereof) to a remote service, such as a network-connected server, for analysis thereby. In some embodiments, various combinations of local and remote audio processing may be utilized to evaluate trigger criteria. If trigger words are not detected, application logic 746 continues monitoring audio sounds (step 800).

If trigger words are detected, application logic 746 causes PED processor 744 to toggle presence control state for the PED (step 810). For example, in the case of a smartphone PED 740, PED 740 may adjust an audio source signal (such as a music player app, podcast app, streaming music app, or the like) that is conveyed to an audio output device (such as headphones), to facilitate the user's awareness and comprehension of their surroundings (including people speaking to them). Adjustments to audio source signals may include pausing playback, reducing audio output absolute volume level, attenuating the overall volume of a particular source of audio (such as attenuating sound from a music player app), filtering specific frequency ranges within an audio signal (such as filtering frequencies overlapping primary portions of typical human voices), or other audio signal processing.

PED 740 may also report its changed presence control state to a network-connected presence controller, such as controllers 104, 114 or 160 (step 815). The user's presence state may in turn be updated by the controller(s) for other users, such as by updating the user icon periphery color for user icons in the mobile app display of FIG. 5.

Selective and Distributed Microphone Utilization

While certain embodiments described above utilize microphones integrated into headphones, such as microphone 603, it is contemplated and understood that in other embodiments, remote microphones may be utilized. In particular, it may be desirable to utilize a microphone integrated within a PED, such as PED microphone 747, for detection of ambient sound. Such embodiments may be particularly beneficial in circumstances where the PED consists of, or includes, a device having a microphone that may be located separately from an associated sound producing component, such as a smartphone implementing a mobile app with separate headphones connected thereto (whether wired headphones or wireless). For example, while many headphones have integrated microphones, use of an onboard PED microphone 747 eliminates dependency on the particular headphones that a user is employing, as some headphones do not include microphone capabilities. PEDs may also provide a more standardized microphone hardware specification and audio profile, thereby improving the reliability and effectiveness of audio processing.

Selective or distributed microphone utilization may also be beneficially used to mitigate microphone latency issues that can be particularly challenging in some applications. For example, to the extent a wireless headset is used, the headset wireless communication protocol may introduce some appreciable amount of audio signal latency in transmitting recorded audio from the headphones to the PED using standard audio transmission paths. This latency effect can be particularly noticeable in common wireless headsets paired to a smartphone using a Bluetooth wireless communications link. Most headphones have limited ability to reduce a user's perception of ambient sounds; even sealed-ear type earphones typically allow an attenuated, but noticeable amount of sound to be conducted directly through to a user's ears. Typical wireless headset microphone latency may be imperceptible or not objectionable in applications such as telephony or other applications in which a user's voice and/or ambient sounds are being transmitted to a remote location or recorded for playback later. However, when microphone sounds are being played back in substantially real time to a user physically present in the ambient environment (whether mixed in with another audio source or not), significant echoing or other objectionable effects may be readily observed by a user. Microphone latency may be greatly reduced, or even substantially eliminated, in such applications through use of a microphone integrated directly with the PED performing audio processing, rather than within a wireless headset. Alternatively, it may be desirable to implement a special audio processing path for such applications, to prioritize wireless audio; such audio processing software may be implemented within a mobile phone application and/or mobile OS.

Moreover, some embodiments may provide a spatially distributed network of microphones that can be leveraged to better control ambient sound perception, and mixing of ambient sounds with audio source signals. For example, a single user PED may include a smartphone having a built-in microphone, as well as a headset having a built-in microphone. The smartphone and headset microphones may be spatially distributed—particularly to the extent that the headset may be wireless. Audio processing applications, such as those described elsewhere herein, may selectively utilize either or both microphones, depending on, e.g., which microphone is better positioned to perceive a desired sound source.

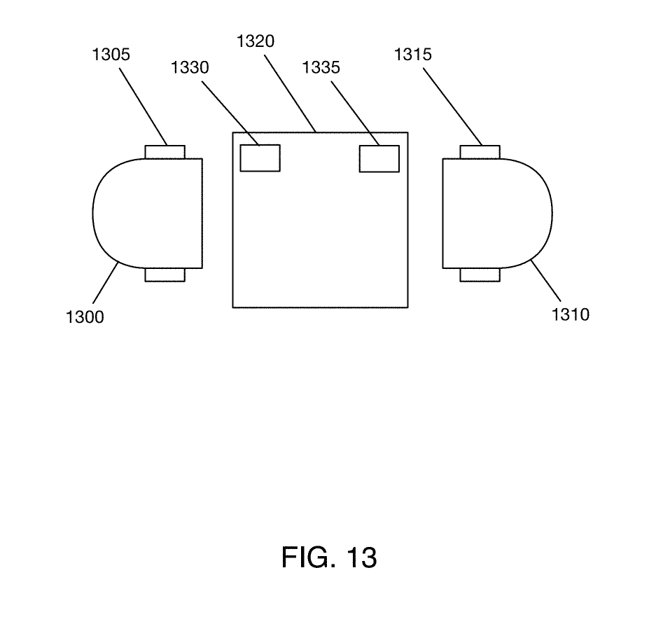

One exemplary use case for distributed microphone utilization is illustrated in FIG. 13. FIG. 13 is a schematic illustration of two individuals, users 1300 and 1310, seated at table 1320 in a noisy area, such as a busy restaurant. User 1300 wears wireless headset 1305, such as Apple Airpods or another Bluetooth wireless headset. Headset 1305 is paired with user 1300's mobile phone 1335. Similarly, user 1310 wears wireless headset 1315, which is paired with user 1310's mobile phone 1330. Each headset 1305 and 1315 includes an integrated microphone. Each mobile phone 1330 and 1335 also includes an integrated microphone.

Mobile phones 1330 and 1335 may be distributed spatially, relative to their respective users and the headsets with which the mobile phones are paired. Thus, a microphone within user 1300's headset 1305 may perceive different ambient sounds than the microphone within that user's smartphone 1335, or it may perceive a difference balance of ambient sounds, due to, e.g., proximity to variation sound sources and/or directionality of associated microphones. This spatial independence and resulting selectivity for ambient sounds may be beneficially utilized in many applications.

For example, in a scenario in which users 1300 and 1310 are seated around table 1320 in a noisy restaurant, one or both users may have difficulty hearing the other user speaking. Such difficulties may be particularly challenging for individuals with varying levels of hearing impairment. However, each user may position their smartphone on table 1320 to be physically located proximate another individual with whom conversation is desired. In the case of user 1300, user 1300 may position their smartphone 1335 much closer to user 1310 than user 1300 himself/herself, and closer than user 1300's headset 1305. The microphone integrated within smartphone 1335 may then be utilized to perceive ambient sounds, and feed them through for playback via the user's headset 1305. Because the user's smartphone 1335 microphone is positioned physically closer to user 1310 than both headset 1305 and user 1300 himself/herself, ambient sound perceived by smartphone 1335 microphone may exhibit higher selectivity for user 1310's speech sounds.

The selectivity provided by variable microphone positioning and orientation may be further supplemented by audio processing, e.g. by smartphones 1330 and 1335. For example, various noise rejection and cancellation processes may be applied to further reduce unwanted sound components, such as non-speech sounds, or distant sounds. Equalization or other audio processing may also be applied to enhance sound perception, based on the nature of the sound being perceived and/or characteristics of the user.

In some circumstances, audio processing components integrated within a PED may be repurposed to improve live perception of ambient sounds. For example, many smartphones implement audio processing functions intended to improve voice sound isolation (or reject non-voice ambient noise) when transmitting a user's voice to remote locations, such as telephony applications or providing voice chat during gaming. One such function in an Apple iPhone is referred to as GAME CHAT mode. Such functions may be beneficially repurposed for live microphone processing applications described herein, such as for isolating voices perceived by a smartphone microphone (or a remote microphone paired with or connected to a smartphone) in the user's ambient environment, for live playback to the smartphone user—possibly mixed with music or another audio source.

Using such audio processing functions, some embodiments may be effectively used by those who are hearing-impaired, to improve their ability to hear in certain environments. Many embodiments may be effectively implemented using a standard smartphone and headphones, without requiring specialized hardware. In some embodiments, the PED arrangement utilizing spatially distributed microphones may be beneficially combined with other functionality, arrangements and use cases described herein, such as mixing of ambient sounds with selective remote audio sources by a smartphone application.

Toggling Presence Control with Device Gestures

While a smartphone PED may present a graphical user interface enabling detailed control over immersion state, in some circumstances, a user may wish to toggle their immersion state in circumstances when the appropriate mobile application is not active. For example, another individual may walk up to a user to begin a conversation, while the user's smartphone is locked and/or active in another application. Alternatively, collaborative features may change a user's immersion state for a given communication event, and afterwards the user may wish to quickly toggle back to another immersion state. In such circumstances, it may be desirable to facilitate immersion state toggling with device gestures that may be accessed regardless of the user's PED lock state or foreground application. In one such embodiment, application logic operating on a smartphone PED may access accelerometer and orientation sensors integrated within the smartphone to track device movement and orientation as a background process. In the event that the background process detects a predetermined movement of the smartphone PED, the immersion state may be toggled as described elsewhere herein. For example, while a smartphone is resting on a flat table, rotation of the device 90 degrees counterclockwise may initiate a conversation mode in which ambient sounds are mixed into the user's audio stream, while rotation of the device 90 degrees clockwise may toggle the device immersion state to eliminate passthrough of ambient sound. Additionally or alternative, vigorous shaking of the smartphone may be detected to trigger toggling between introducing or eliminating ambient sounds from a user's audio stream. These and other gestures may be used to control immersion state and/or other preferences or settings in various embodiments described herein.

Collaborative Audio for Voice Chat

In some embodiments, systems and devices described herein may also be utilized to facilitate convenient voice communications amongst users of immersive devices such as headphones, whether the users are located near one another or remotely.

Unlike other chat and communication tools, embodiments may leverage the detection and incorporation of immersive technology use, in order to facilitate communication to and from the immersive technology user and others (who may be using immersive technology products or not). For example, for users of headphones, a smartphone app may: detect whether and what audio source is active (e.g. if the user is listening to music), identify which audio output device is active (e.g. if the user has headphones connected to the device), and read any additional signals available to the app pertaining to a user's level of immersion (such as immersion status information as described in applicant's co-pending U.S. provisional patent application No. 62/474,659, filed Mar. 22, 2017, the contents of which are hereby incorporated by reference) to provide a context-specific action or attempt to communicate with the user. Further in the example, if a headphone user participates in an audio messaging application (such as those described further below) and doesn't have their headphones on, the audio messaging application may queue audio communications for later playback, waiting until the user places the headphones on (as detected by, e.g., a headphone being plugged into a device audio jack or paired by Bluetooth). A more complex implementation for determining immersion status may include sensors that can determine whether earphone are present in a user's ear (e.g. via an in-ear light sensor or the like). Such embodiments may leverage further awareness and context regarding a user's immersive-ness status to provide more efficient communication methods, such as delaying delivery of an audio communication, or playing an audio communication directly to a user's ears without the user having to go to a chat platform or accept a phone call—all based on a user's immersion status.

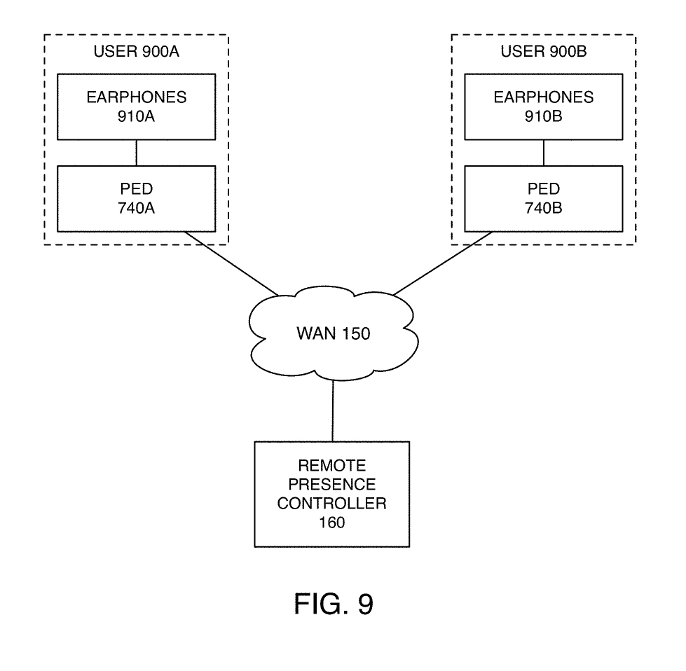

FIG. 9 is a schematic block diagram of a computing environment for implementing such a system, in accordance with one embodiment. User 900A uses smartphone personal electronic device 740A, in conjunction with earphones 910A. User 900B, who may be located remotely from user 900A, uses smartphone personal electronic device 900B in conjunction with earphones 910B. Smartphones 740A and 740B are both connected with data wide area network 150. Remote presence controller 160 also communicates via network 150.

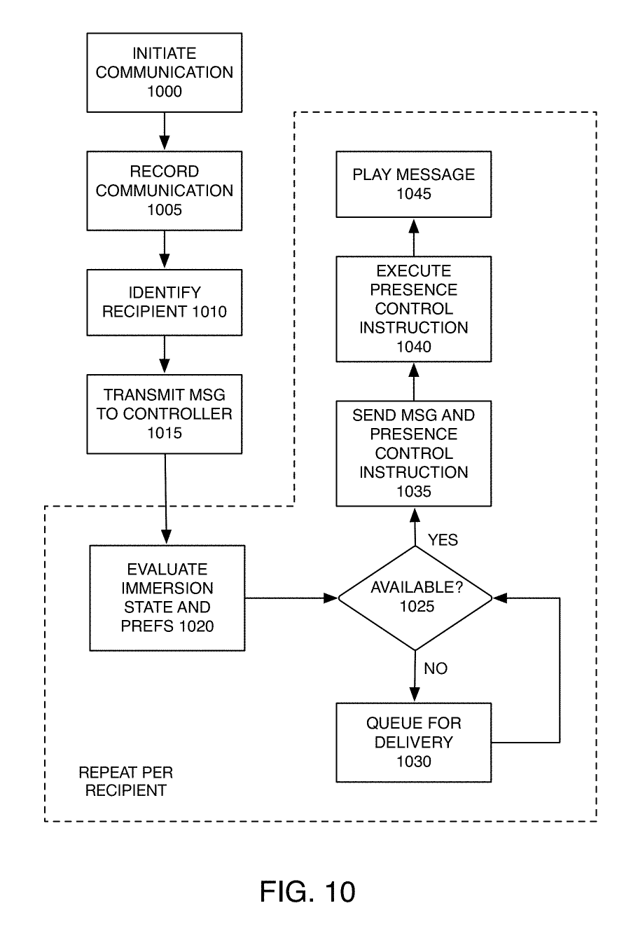

FIG. 10 illustrates a process for ad hoc voice communications within the environment of FIG. 9. In step 1000, user 900A initiates a voice communication intended for user 900B. Preferably, a user may simply begin talking, with PED 740A thereafter recording and analyzing speech content. In some embodiments, a predetermined cue word or phrase may be utilized to trigger the beginning of a voice communication. In yet other embodiments, the user may initiate the communication via interaction with PED 740A and/or earphones 910A, such as be pretty a physical or logical button on a device user interface.

In step 1005, PED 740A records the audio message intended for transmission. In some embodiments, audio may be recorded directly by microphone 747, integrated within PED 740. Use of integrated microphone 747 may reduce latency and provide consistent gain and other audio characteristics. However, the ability of integrated microphone 747 to isolate a user's voice from background noise may be very limited, particularly because users may place PED 740 in varying locations such as the user's pocket, on a tabletop, or the like. In some embodiments in which a user's headphones include one or more microphones, it may be beneficial to use the microphone capability integrated within a user's headphones in order to capture the user's spoken audio in step 1005. Headphone microphones are typically arranged with an objective to maximizing isolation of a user's voice from surrounding sounds. In some embodiments, headphones may provide an array of directional microphones with signals combined by a noise cancellation or rejection mechanism to further isolate a user's voice. In yet other embodiments, earphones forming an airtight seal with the user's ear opening may include one or more microphones facing inwards to the user's ear canal. The sound of the user's voice may travel up through the user's Eustachian tubes to reach such inward-facing microphones, thereby providing high levels of isolation from ambient noise. These and other arrangements may be utilized to record a user's spoken audio message in step 1005.

In step 1010, PED 740A identifies the intended recipient for the voice communication initiated in step 1000. Preferably, the intended recipient for the communication may be determined automatically based on the communication content. In such embodiments, for example, a microphone within earphones set 910A and/or PED 740A detects audio that is recorded by PED 740A, and analyzed for references indicative of intended recipient. For example, a speech to text analyst may be applied to the recorded audio (by PED 740A, or remotely) to derive corresponding text. The corresponding text may then be analyzed for indication of intended recipient. Analysis may include, for example, simple cross referencing of words with individual names stored as contacts within PED 740A, or individual names previously identified as desired communication recipients in connection with a user profile for user 900A. A natural language processing component may also be applied to the detected text for improved parsing reliability. In some embodiments, adaptive or machine learning mechanisms may also be applied to improve the likelihood of correctly identifying an intended recipient. For example, a supervised machine learning mechanism may identify correlations between time of day and day of week, with intended recipients (such as children frequently sending messages to their parents after school, workers messaging their co-workers during regular working hours, or an individual regularly messaging their spouse towards the end of a work day or during a commute home). Such automated recipient identification mechanisms may be performed via onboard processing within PED 740A and application logic implemented thereby, via onboard processing that may be provided within earphones 910A, via a remote server such as remote presence controller 160, via other remote, network-connected speech recognition and language processing APIs, or via combinations of local device and remote audio and language processing. Automated recipient identification mechanisms may also beneficially integrate with a user's calendar and contacts data, whether stored and accessed directly on PED 740A, or via API calls to network-connected services. In lieu of or in addition to such mechanisms for automated recipient identification, user 900A may also be provided with a user interface on PED 740A for manual selection of an intended communication recipient (or to confirm the identify of a recipient detected automatically).

Users may also designate groups for receipt of audio messaging. In embodiments providing presence control groups, such as those described above in connection with FIGS. 1-5, the same presence control groups may be utilized for identifying recipients of audio messaging. This may be particularly beneficial to the extent that groups are dynamic. For example, a presence control group may include a company's active co-workers, thereby enabling announcements to all users who currently working. Thus, multiple intended recipients may be identified in step 1010.

In step 1015, PED 740A transmits the recorded message and the identity of the intended recipient(s) to remote server 160. In embodiments in which remote server 160 operates to analyze the recorded message to identify intended recipient(s), the order of steps 1010 and 1015 may be reversed.

In step 1020, remote presence controller 160 initiates a message delivery process for each recipient. In particular, remote presence controller 160 initially evaluates the immersion state and notification preferences for each intended recipient. Based on the user's current immersion state and preferences, a determination is made as to whether the message should be delivered now or queued for later delivery. If queued (step 1030), server 160 may monitor the user's immersion state and preferences until the recipient is available for message delivery. While the embodiment of FIG. 10 contemplates queuing of messages on presence controller 160, in other embodiments, where recipient PED 740B is available on WAN 150 but recipient preferences preclude immediate delivery of the audio message, the message may also be delivered to PED 740B immediately, and queued locally by application logic 746, effectively shifting queuing step 1030 to PED 740B, after message transmission step 1035. Application logic 746 may then monitor the recipient's immersion state and preferences, towards executing any required presence control instruction and delivering the message when permitted.

If the recipient's state permits delivery of the message, presence controller server 160 transmits the audio communication and presence control instructions to the recipient PED (step 1035). In step 1040, the recipient PED executes the presence control instruction. Typically, the recipient PED will apply its user's “conversation mode” preferences, such as pausing any currently playing audio source, or reducing the audio source gain, and/or attenuate the primary voice frequency range to minimize perceptual interference with the message to be delivered. Ambient sounds may continue to be mixed in during delivery of the audio message, such that the remote message joins ambient sounds similarly to if the remote user was present with the recipient. Alternatively, ambient sounds may be partially or wholly attenuated to focus the user's perception on the audio message to be delivered. In various embodiments, the recipient PED 740B may vary the audio mix and audio processing of sounds delivered via earphones 9108 to contain varying levels of audio source, ambient sound and remotely delivered audio message. Such audio attributes for PED 740B may be determined based on predetermined system rules, user-specified preferences, predictive preferences (such as determined by an adaptive machine learning component implemented locally on PED 740B and/or remotely on presence controller server 160), or combinations thereof.

In step 1045, the message is played back by PED 740B and earphones 910B.

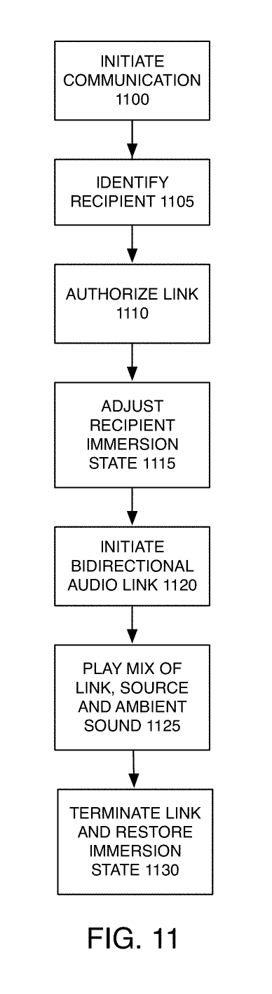

While the embodiment of FIG. 10 illustrates mechanisms for delivery of a discrete audio communication, it is also contemplated and understood that remote presence controller 160 may additionally or alternatively facilitate substantially real-time, bidirectional voice communications, while implementing user-specified mixing of the remote audio-connect, a local audio source such as a music player, and ambient sound. In so doing, remotely located individuals may engage in voice communications in a matter that is natural, and closely replicates the way a user would speak with the individual in person, all without requiring the users to remove their headphones. FIG. 11 illustrates an exemplary process. In step 1100, a communication link is initiated by initiator PED 740A, e.g. via transmitting a link request to presence controller 160. In step 1105, the intended recipient(s) are identified, analogously to step 1010 in the embodiment of FIG. 10. In step 1110, recipient PED 740B may authorize the communication link, thereby avoiding undesired transmission of the recipient's microphone sound to others. In step 1115, recipient PED 740B adjusts its immersion state, e.g. by one or more of activating or deactivating noise cancellation features, optionally pausing an audio source, and/or adjusting gain and equalization applied to the remote audio call, audio source sounds, and ambient sounds. In step 1120, a bidirectional audio communication link is established between PED 740A and PED 740B (potentially via VOIP service provided by server 160). In step 1125, once the call is initiated, PED 740B replicates the desired mix of audio combining one or more of the remote audio call, local audio source sound and ambient sounds. Users 900A and 900B may thereafter engage in casual conversation. Once a user is finished with the audio connection, the link may be terminated and the user's prior immersion state may be restored by their PED (step 1130).

Integration with Diverse PEDs

While some embodiments described herein may utilize PEDs uniquely configured for integration with a presence controller, such as special-purpose headphones or a smartphone implementing a mobile app provided by a presence control service provider, it is also contemplated and understood that diverse electronic devices may be readily integrated with presence controller services. For example, cloud-based presence controller 160 may provide one or more Application Programming Interfaces (APIs) to enable third party devices to integrate with presence controller services. Such devices, particularly devices having speakers, one or more microphones, and microprocessors, may readily provide for integration as an alternative PED.

One such diverse device that may be desirable for integration with presence controller 160 is home assistants, such as the Amazon Echo, Google Home or Apple HomePod. While these devices provide open-air audio without ambient sound isolation, they may nevertheless act as end points for delivery of audio messaging or bidirectional audio chat, as described herein. While local application logic may not need to control mixing of ambient sound for such an open air endpoint PED, it may nevertheless control immersion preferences (such as availability for interruption by remote audio messaging), as well as dynamic attenuation, equalization or other audio processing of diverse audio streams during playback of audio messaging or during two-way audio communications.

Location-Based Services

In some embodiments, it may be desirable to implement location-based services. For example, a user discovery service may be provided, so that users can identify other users nearby, such as to request adding that user to a presence control or audio interaction group. One technique for such location services may rely on network access identification. As briefly described above, users present on a common local network may rely on standard network discovery services to identify and communicate with other users on the same network. Such embodiments may be effective, for example, for employees present in an office or other place of work, where the employees typically join their personal electronic devices to a company WiFi network.

However, such services may not be effective in environments in which users employ diverse network access techniques. For example, in a retail environment, customers may commonly use cellular data network interfaces, rather than expending effort to join a local retailer wireless network for each retailer visited. In such circumstances, it may be desirable for PEDs to report their location (e.g. using onboard location services, such as GPS) to a presence control server, such as servers 104, 114 and/or 160. The presence control server may maintain a database storing last known location for each PED. A PED may then query the presence control server for nearby devices; the presence control server can compare the querying device's location to the location of other devices, and report back unique identifiers for other devices satisfying the location query criteria.

While tracking device location by a presence control server may be an effective mechanism for implementing location-based services in an environment with a trusted centralized service, such an approach may be undesirable in, e.g., peer-to-peer implementations. For example, privacy and safety concerns may be raised by users reporting their locations to other, unknown devices. In such embodiments, it may be desirable to implement a double-blind location comparison mechanism, so that a device may evaluate its proximity to peer devices, without either device knowing the other's location coordinates. One location comparison mechanism that may be employed utilizes homomorphic encryption. In particular, each PED in a peer-to-peer network of PEDs may apply homomorphic encryption to its location data, before reporting the encrypted location to another device. Calculations may then be applied to the homomorphically encrypted location data to yield results that may be decrypted by either device without knowing the source data from the other device, e.g., a determination of distance between devices, or determination of whether a device's location lies within a threshold distance from another device. These and other location-based services may be optionally implemented in various embodiments.

Location-Based Collaborative Communications and Retailer Marketing

By enabling users to dynamically switch between listening to an audio source and a conversation mode in which users can readily hear and interact with those around them, users may be inclined to wear headphones and consume audio content for longer periods of time and more circumstances. This may give rise to new opportunities for engaging individuals with audio content.

In one potential use case, dynamic audio messaging may be utilized by retailers to deliver targeted, timely audio messaging to individuals present within a retail environment. For example, customers of a retail store may opt into a presence control group associated with the retailer. The retailer may then utilize audio messaging services, such as that described in the embodiment of FIG. 10, to deliver targeted audio communications to the user, in a seamless manner while the user continues to consume the user's own audio content and/or engage with individuals around them. Rather than an audio message being initiated by a user PED 740A, the audio message may be initiated by a retailer application server, implementing configured promotional or advertising campaigns.

Retailer messaging may be targeted by location. For example, using location services such as those described above, a retailer may deliver an incentive or promotional audio message to users nearby the retailer's establishment, with the audio message seamlessly mixed in to an audio stream already being heard by the recipient, as described elsewhere herein. Such embodiments may be particularly desirable for, e.g., retailers within a shopping mall or other high-density retail environment, as targeted audio messages to nearby individuals may increase recipients' tendency to visit the sponsoring retailer—particularly when the message delivers a promotional incentive, such as notice of a sale or discount opportunity.

Retailer audio messaging applications may be integrated with retailer loyalty systems to further personalize user messaging. For example, notice of sale of a particular item could be delivered to individuals whom retailer records indicate as having purchased the item on multiple occasions in the past. These and other promotional targeting mechanisms may be beneficially implemented in combination with the audio message delivery mechanisms described herein.

In some embodiments, retailers may also utilize audio messaging as described herein in conjunction with chatbots configured to originate communications, and respond to customer audio messaging. Chatbots are increasingly utilized to automate customer interactions in online, web-based ecommerce environments, where they can provide customer support services in a manner that is instantaneous, highly scalable, and enriched with deep access to product, retailer and customer information. Such ready access to intuitive, conversational support may provide online retailers with significant benefits, as compared to live retailer experiences in which costly salespeople may be difficult to locate (particularly in large stores) and have limited training and access to information. However, by utilizing systems and methods for audio messaging directly to a customer's existing network-connected personal electronic device, to interact with chatbots utilizing speech-to-text and text-to-speed conversion mechanisms, brick-and-mortar retailers may provide significantly enhanced customer support.

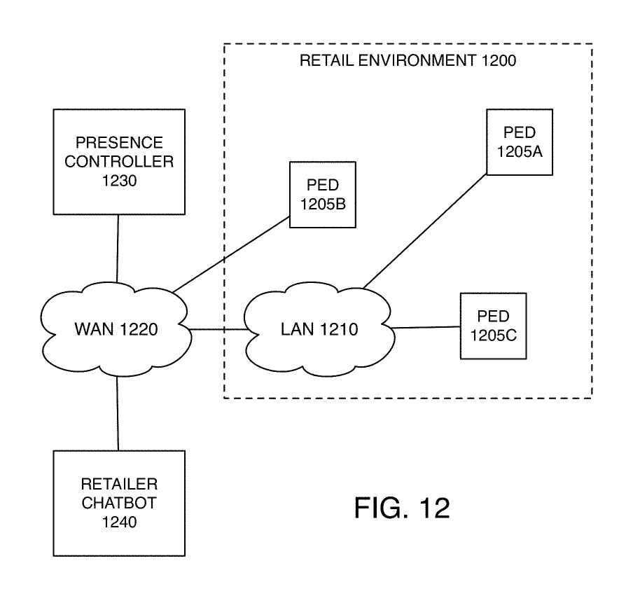

FIG. 12 is a schematic block diagram of a retail environment providing a chatbot to facilitate customer interactions using audio messaging techniques described herein. Retail environment 1200 (which may be, e.g., a big box retail store, department store, or even a smaller retail establishment) has multiple customers navigating the environment, including customers utilizing personal electronic devices 1205A, 1205B and 1205C. PEDs 1205A, 1205B and 1205C may be, e.g., smartphones running an application providing functionality described herein, outputting audio to customer earphones. PEDs 1205A and 1205C communicate via a WiFi local area network 1210 provided by retailer 1200, in order to access wide area network 1220 (e.g. the Internet). PEDs such as PED 1205B may alternatively communicate directly via WAN 1220, such as via an integrated cellular data modem. Presence controller 1230 may operate analogously to other presence controller embodiments described herein. Retailer chatbot 1240 communicates with presence controller 1230 in order to identify customer PEDs 1205 within retail environment 1200, and to send and receive audio messages therewith. Therefore, customers may interact with chatbot-based support very naturally and conversationally, as they would with a live customer service representative. However, chatbot support may be engaged instantaneously, by any or every customer within retail environment 1200, at any time during a customer's visit. Because customers typically carry PEDs 1205 with them, chatbot support may also be engaged continuously as a customer moves around a retail environment. Meanwhile, chatbot 1240 may be provided with rich data to support meaningful customer interactions, such as real-time retailer inventory records, store mapping, product technical specification, customer purchase history, customer preferences and the like.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or any appended claims.

1. A method for transmitting audible content from a remote electronic device to a user mobile device associated with headphones worn by the user, the method comprising:
detecting an interaction event via which a third party electronic device seeks to interact with the user via the user mobile device;
evaluating an immersion state of the user;
applying preferences associated with the interaction event;
transmitting presence control instructions to the user electronic device; and
executing presence control instructions to modify operation of the mobile device and/or the headphones associated therewith.
